(19) United States
(12) Patent Application Publication
(10) Pub. No.: US 2004/0022227 A1
(43) Pub. Date: Feb. 5, 2004

(54) System and method for asset tracking

(76) Inventors: Randall Gene Lynch, Lewisville, TX (US); Christie Louise Lynch, Lewisville, TX (US)

Correspondence Address: Randall G. Lynch, 2018 Woven Trail, Lewisville, TX, 75067, US

(21) Appl. No.: 10/632,246

(22) Filed: Aug. 1, 2003

Related U.S. Application Data
(60) Provisional application No. 60/400,470, filed on Aug. 2, 2002.

(51) Int. Cl. H04B 7/00

(52) U.S. Cl. 370/338; 370/310

(57) ABSTRACT

A system and method for tracking assets in their free-flow movement is provided. The system includes one or more Asset tag devices, such as an RFID transponder device attached to the lower extremity of an asset located within an area. Each Asset tag having Asset Control Data associated herein. This Asset Control Data may, in certain embodiments, be stored in the internal memory storage area of an Asset tag, in an associated database separate from the Asset tag, or in both the internal memory storage area of an Asset tag and an associated separate database or storage device. This Asset Control Data may include, for example, an identification number, personal identification number, e-commerce account balance or any other suitable control data.

One or more Reader Stations as boundaries, dividing an area into sectors and receiving and transmitting Asset Control Data, such as by transmitting the Asset Control Data over wireless media from each Asset tag to the Host System and Reader Stations. One or more Host Systems that perform one or more functions based on the Asset Control Data and Reader Control Data, such as positioning an Asset tag in its free-flow movement within an area, as well as calculating and displaying physical/virtual line queue information and displaying high traffic volumes on Display Boards throughout an area.

### RELATED APPLICATIONS

The present application is related to and claims priority to U.S. Provisional application No. 60/400,470, “System and method for amusement park asset tracking,” filed Aug. 2, 2002, Randall G. Lynch and Christie L. Lynch, inventors.

### FIELD OF THE INVENTION

The present invention pertains to the field of asset tracking systems. More specifically, the invention relates to a system and method for tracking visitors, employees and equipment, referred to herein as independently mobile assets or just assets, that allows theme/amusement parks, water parks, ski and other resorts, shopping malls, skateboard parks, skating rinks, conventions, trade shows, sporting events and other facilities to capture detailed positioning information for traffic flow analysis, physical/virtual line queue calculation and display, statistical/demographic information, display real-time traffic flow patterns and bottlenecks, provide real-time promotions, increase security, increase efficiencies, take photographs based on activities, determine asset speed and horizontal/vertical distance traveled as well as providing information that the end user can use in order to locate friends and family, review personal statistics, communicate with one another, review action photographs and utilize e-commerce accounts.

### BACKGROUND OF THE INVENTION

Visitor tracking systems are known in the art. These visitor-tracking systems allow the location of visitors in theme/amusement parks, water parks, and other facilities to be tracked. Such visitor tracking systems utilize expensive technologies such as RTLS (Real-Time Location Services), TDOA (Time Difference of Arrival) or systems that utilize expensive active RFID transponders in order to position the visitors throughout an area.

Because of the cost associated with providing each visitor with these expensive locating devices, parks and resorts have been unable to supply a location device to every visitor that enters an area. Not being able to supply all of the visitors with the location device, limits the parks, resorts and facilities functionality of the system, thus several of the benefits of having a tracking system all together. Using these expensive systems, the park/resort is unable to monitor the traffic flow patterns for all assets within an area. Due to the cost associated with these system's location devices, only the visitors that rent a location device (averaging less than 10%) can be tracked throughout an area.

With the introduction of passive Radio Frequency Identification (RFID) it has become cost effective to outfit each and every visitor, employee and equipment piece within an area to be positioned. RFID transponders can be passive or active and they can include a transceiver, a transmitter only or a receiver only. Passive RFID transponders come in two varieties: inductive and capacitive. Passive RFID transponders utilize resonating radio frequencies as a power source used to provide power to the RFID transponder for transmission or receiving. Active RFID transponders contain their own power source such as a battery, have a limited lifecycle and are more expensive but have a longer transmission range.

Systems have been designed to place active or passive RFID transponder bands on the visitor's upper extremity, such as their wrist. This, due to passive RFID limitations, does not allow for “free-flow” tracking of the visitor's position and if the RFID transponder is an active transponder, is too costly to provide RFID transponders to each visitor. “Free-flow” positioning is defined as: Positioning a mobile asset throughout a sectored area without having the asset perform special movements or alter their movement patterns in order for a system to communicate with the asset's passive RFID transponder, which is necessary in order to position the asset's location in the area. Such as the visitor having to approach a kiosk machine or turnstile and place their RFID transponder in the vicinity of an RFID reader station in order to be located.

The only feasible system design to allow for “free-flow” positioning using inexpensive, disposable passive RFID transponders must take into account the read/write range of passive RFID technologies based on the size of the passive RFID transponder, the frequency at which the RFID transponder can communicate and the signal strength. In order to maintain a convenient, comfortable, inexpensive, disposable passive RFID transponder that does not use harmful signal strengths, the read/write range of the passive RFID transponder must be a short distance from the RFID reader antenna to the passive RFID transponder. Thus, placing the passive RFID transponder on the visitor's upper extremity requires the visitor to change their “free-flow” movement habits in order to be positioned by the system. The only way for the visitor to be positioned in “free-flow” movement, when the RFID transponder is placed on the upper extremity, is for the RFID transponder to be an active RFID transponder due to the increased read/write range needed by the more expensive active RFID transponder.

### SUMMARY OF THE INVENTION

The present invention overcomes passive RFID read/write limitations in current system designs and allows for “free-flow” asset positioning by placing the passive RFID transponder in close vicinity to the RFID reader's antenna(s) located throughout an area without altering the asset's “free-flow” movement patterns. Since the present invention's system and method can utilize inexpensive, disposable passive RFID transponders, all assets within an area can cost effectively obtain a locating device and other features can be disclosed in the present invention that include: calculating and displaying physical line queue wait times, displaying high-traffic areas (sectors that have been determined by the number of assets currently in them as being over-crowded), referred to herein as hot-spots, determining asset speed and distance traveled (vertical/horizontal) and real-time promotions based on asset's location. A physical line queue is defined as an area designated for waiting within a line for a ride, attraction or some other activity.

In particular, a system and method for tracking assets is provided that includes boundaries in order to create location sectors of an area. Boundaries are created by placing RFID reader's or interrogator's such as a Texas Instruments HF Reader System 6000 S6110 Reader Module, referred to herein as a Reader Station [300], Antenna(s) across a surface. This design allows for the asset's passive RFID transponder, located on the lower extremity of the asset, referred to herein as Asset tag [600,700,800], to be communicated with as it passes, in close vicinity, to the Reader Station's [300] Antenna(s) (boundary) in order for the system to locate the asset in it's “free-flow” movement pattern. Lower extremity is defined as below a thirty inch distance to the surface, such as the waist, ankle, leg of a person, undercarriage of a wheelchair, undercarriage of a cart, undercarriage of a car, truck or tram.

In accordance with an exemplary embodiment of the present invention, a system and method for tracking assets is provided. The system includes one or more Asset tags [600,700,800]. Each Asset tag [600,700,800] containing an RFID transponder to store or having the ability to store information such as an identification number, e-commerce account data and other suitable control data, herein referred to as Asset Control Data. Each Asset tag's [600,700,800] identification number, referred to herein as Identification Data, being correlated to other control data housed in a database, such as an Oracle or Microsoft SQL server database containing one or more tables, herein referred to as a Correlation Database, such as demographic or identification data about the asset. Each Asset tag [600,700,800] having the ability to be grouped or linked to other Asset tags [600,700,800] within the Correlation Database [100A] and/or within the Asset tag's [600,700,800] internal memory storage.

One or more Reader Stations [300] having the ability to read and/or write Asset Control Data to an Asset tag [600,700,800], a Host System [100] housing a Correlation Database [100A]and/or a System Interaction Console [400] and having its Antenna(s) creating a boundary or boundaries throughout an area that transmits and receives Asset Control Data from and/or to the Asset tag [600,700,800], Host System [100]and System Interaction Console [400].

One or more Host Systems [100] that processes control data and/or stores control data in a Correlation Database [100A]. One or more Host Systems [100] that performs one or more functions based on the control data, such as calculating and displaying the location of one or more Asset tags [600,700,800], determining physical/virtual line queue wait times and displaying said calculations, processing e-commerce transactions, granting access to authorized areas and displaying messages.

A System Interaction Console [400] used to interact with an end user, Host System [100], Asset tag [600,700,800], and/or Reader Station [300]. The System Interaction Console [400] is defined as a kiosk machine or personal computer that utilizes a keyboard, touch screen, mouse, radio frequency, light and/or audio/visual, referred to herein as input methods, for input and communication by the end user. The System Interaction Console [400] is used to provide information to the end user such as displaying reports, modifying e-commerce account data, send messages to other assets or end users, or to interact with the Host System [100]and/or Host System's [100] Correlation Database [100A].

One or more large monitors, LED tickers or projectors that display information for the end user within an area, referred to herein as Display Boards. Display Boards [200]located throughout the area used to display calculated traffic data such as the number of assets within the sectors of the area, important facility information, line queue data and/or real-time promotions. Display Boards [200] receive their data from the Host System [100].

The present invention provides many important technical advantages. One important technical advantage of the present invention is a system and method for tracking assets that allows asset position/location to be monitored in its “free-flow” movement state. The present invention thus allows the park/resort or facility to analyze traffic flow patterns, determine employee movements and efficiencies, equipment positioning and usage, display and/or transmit real-time promotions based on visitor's position, track, calculate and display statistical information, determine, calculate and display physical/virtual line queue wait times as well as providing location data to end users for friends and family locating services. The system also allows end users to utilize e-commerce accounts and increase safety and security by limiting and/or monitoring asset positioning throughout the facility. Elements of the invention can also be used where asset location tracking is not performed.

Those skilled in the art will further appreciate the advantages and superior features of the invention together with other important aspects thereof on reading the detailed description that follows in conjunction with the drawings.

### BRIEF DESCRIPTION OF THE SEVERAL VIEWS OF THE DRAWINGS

FIG. 1 is a diagram of a system for asset tracking in accordance with an exemplary embodiment of the present invention;

FIG. 2 is a flowchart of a method for registering an Asset tag [600,700,800] in accordance with an exemplary embodiment of the present invention;

FIG. 3 is a flowchart of a method for transmitting control data in accordance with an exemplary embodiment of the present invention;

FIG. 4 is a flowchart of a method for interaction between the Host System [100] and an end user through the use of a System Interaction Console [400] in accordance with an exemplary embodiment of the present invention;

FIG. 5 is a flowchart of a method for the calculation and display of physical line queues in accordance with an exemplary embodiment of the present invention;

FIG. 6 is a flowchart of a method for the calculation, entry and display of virtual line queues in accordance with an exemplary embodiment of the present invention;

FIG. 7 is a flowchart of a method for the interaction between the System Interaction Console [400], Host System [100] and the end user during e-commerce account transactions in accordance with an exemplary embodiment of the present invention;

FIG. 8 is a flowchart of a method for locating assets using a System Interaction Console [400] in accordance with an exemplary embodiment of the present invention;

FIG. 9 is a flowchart of a method for communicating between end users using messaging services in accordance with an exemplary embodiment of the present invention;

FIG. 10 is a diagram of a system for Reader Station [300]communication that allows for single point of reference positioning and multiple point of reference positioning in accordance with an exemplary embodiment of the present invention;

FIG. 11 is a diagram of a system that allows for physical line queue wait time calculations and display in accordance with an exemplary embodiment of the present invention;

FIG. 12 is top-down and side view diagrams of a system for System Interaction Console's [400] communication that allows for an Asset tag [600,700,800] to be identified at the System Interaction Console [400] using “free-flow” movement in order to utilize the System Interaction Console [400] in accordance with an exemplary embodiment of the present invention.

### DETAILED DESCRIPTION OF THE INVENTION

In the description that follows, like parts are marked throughout the specification and drawings with the same reference numerals, respectively. The drawing figures might not be to scale, and certain components can be shown in generalized or schematic form and identified by commercial designations in the interest of clarity and conciseness.

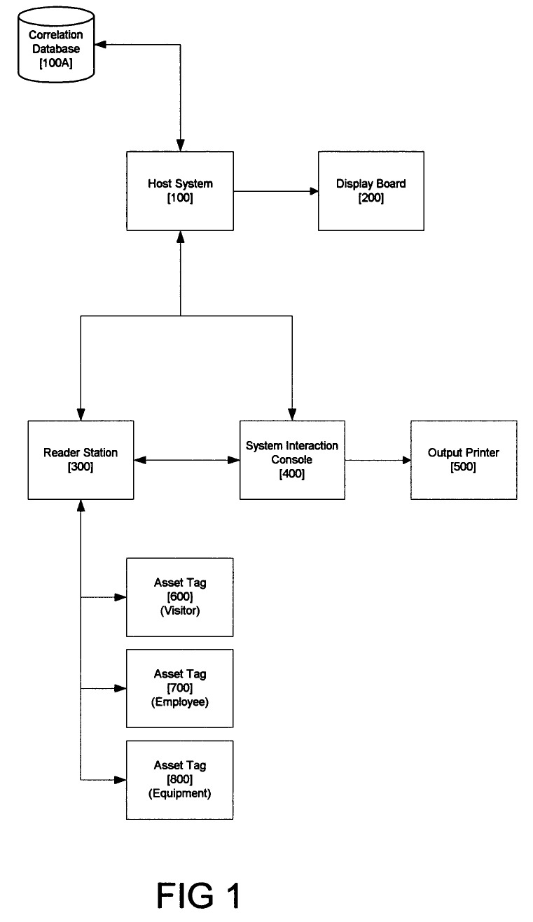

FIG. 1 is a diagram of a system for asset tracking in accordance with an exemplary embodiment of the present invention. The system allows asset tracking to be incorporated into areas sectored by boundaries determined by Reader Stations [300] located throughout the area, such as employing Reader Stations [300] throughout theme/amusement parks, water parks, ski resorts, skateboard parks, skating rinks, shopping malls, conventions and tradeshows, so as to allow additional functions that are made possible by tracking to be incorporated into the asset's visit or usage. Likewise, some of the features of the system can also or alternately be used where the tracking of assets is not performed.

The system includes one or more Host Systems [100] which can be implemented in hardware, software, or a suitable combination of hardware and software, and which can be one or more software systems operating on a general purpose server platform, such as one or more Hewlett Packard ProLiant DL560 servers, each having dual Intel Xeon 2 Ghz processors, 1 Gb base memory, and 100 Gb hard drive storage. As used herein, a software system can include one or more objects, agents, threads, subroutines, separate software applications, two or more lines of code or other suitable software structures operating in two or more separate software applications, on two or more different processors, or other suitable software architectures.

The Host System [100] containing a Correlation Database [1OOA] is used to process, store, log, and or output Asset Control Data received from Asset tags [600,700,800], Reader Stations [300] and System Interaction Consoles [400] in order to provide the processing and output functionality of the present invention.

Display Boards [200] interface with the Host System [100] and are located throughout the area in order to display hot-spot sectors for end users to determine where groups of assets are located at any given time. The Display Board [200] can be implemented as a video output device, such as a monitor, projector or LED ticker that projects or displays a top-down view of the area where hot-spot sector(s) can be outlined or displayed in an identifying manner or as a list with location descriptions capable of displaying the number of assets within the sector. Display Boards [200] can also be used to display real-time information, physical/virtual line queue calculations, wait times and other messages.

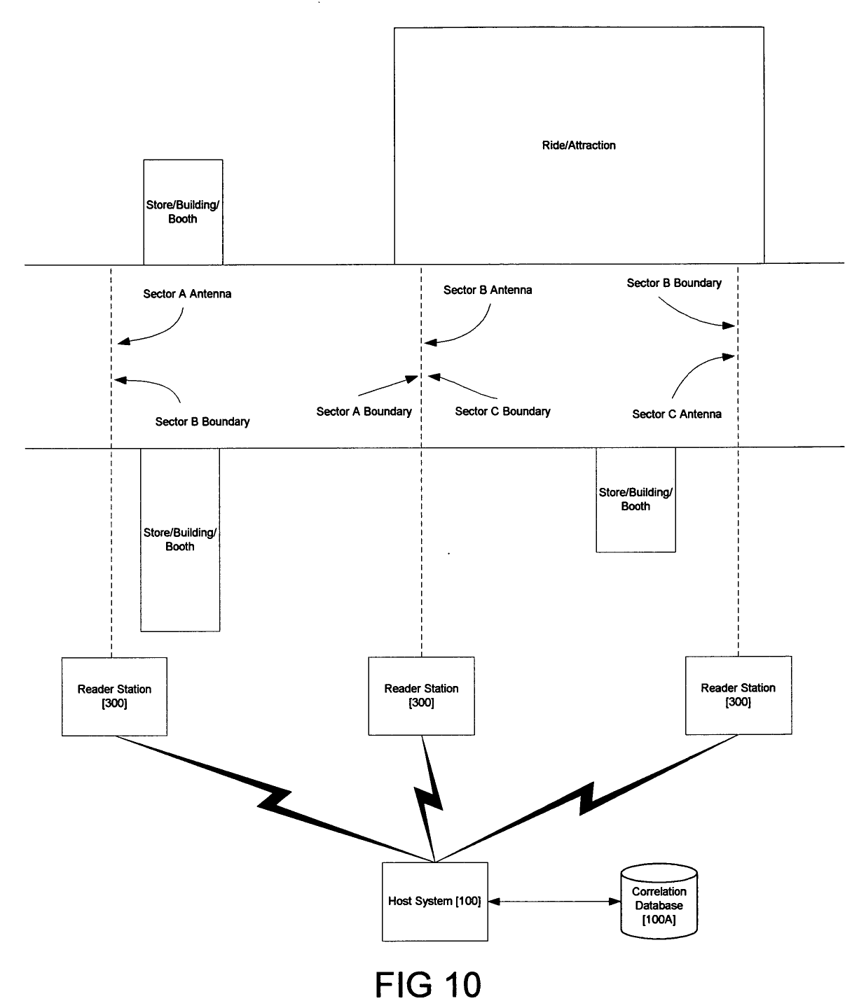

Reader Stations [300] are positioned throughout the area and are used to communicate Reader Station's [300] control data, such as identification number, location ID, or any other suitable control data, herein referred to as Reader Control Data, and Asset tag Control Data to the Host System [100] and/or System Interaction Console [400]. The Reader Station [300], such as a RFID reader manufactured by Texas Instruments can communicate Asset Control Data, once received from the Asset tag [600,700,800], with the Host System [100] or System Interaction Console [400] using one of a variety of protocol methods including but not limited to wireless radio frequencies, light or copper wiring. The Reader Station [300] communicates with the Asset tags [600,700,800] using radio frequencies. Placing the Reader Station's [300] Antenna(s) across a section of an area used for asset traffic flow, referred to herein as pathways, allows Asset Control Data to be read and written to within a close vicinity and provides free-flow positioning, because the asset is not required to alter its movement pattern in order to be positioned; Refer to FIG. 10.

Asset tags [600,700,800] are passive RFID transponders attached to the lower extremity of an asset in order for the Asset tag [600,700,800] to be in close vicinity to the Reader Station's [300] Antenna(s) that are placed across the asset's pathway. The location of these RFID transponders on the asset must be within the read/write range of the Reader Station's [300] Antenna(s) in order to provide “free-flow” positioning. These Asset tag's [600,700,800] RFID transponders can store Asset Control Data such as, identification number, e-commerce account information, personal identification numbers and any other data that could be used as control data. Asset tags [600,700,800] communicate wirelessly with Reader Stations [300] in order to transmit Asset Control Data with the Host System [100] and System Interaction Console [400].

System Interaction Consoles [400] are placed throughout the area and are used by end users, such as employees and visitors to communicate and interact with the Host System [100] and Asset tags [600,700,800]. End users can utilize a keypad, touch screen, mouse, light, voice or radio frequencies to communicate with the System Interaction Console [400]. System Interaction Consoles [400] are utilized by end users to output control/processed data, modify control/processed data as well as communicate with other end users, enter line queues, modify e-commerce account information, register Asset tags [600,700,800], and display park, resort or facility information. System Interaction Consoles [400] can utilize Reader Stations [300] to transmit Asset Control Data and communicate with the Host System [100] and/or Asset tags [600,700,800].

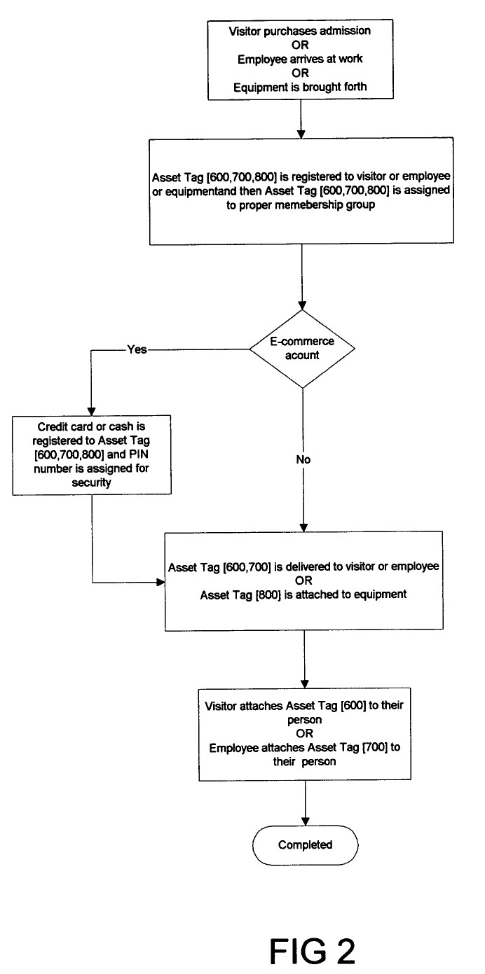

FIG. 2 is a flowchart of a method for registering an Asset tag [600,700,800] in accordance with an exemplary embodiment of the present invention. The Asset tags [600,700,800] must be registered with the Host System [100] in order for the Host System [100] to correlate and uniquely identify each asset being positioned throughout the area. Referring to FIG. 2; the visitor purchases admission (the Asset tag [600,700,800] can replace the admission ticket) or the employee arrives at the park, resort or facility or the equipment to be monitored is brought forth. The employee managing the registration process then registers the Asset tag [600,700,800] using the System Interaction Console [400]. The Asset tag [600,700,800] when registered can be assigned or correlated to a membership group and have e-commerce account information entered and assigned.

The registering employee then provides the Asset tag [600,700,800] to the visitor or employee to attach to their lower extremity. If the Asset tag [800] is for a piece of equipment, then the registering employee attaches the Asset tag [800]to a lower extremity of the equipment.

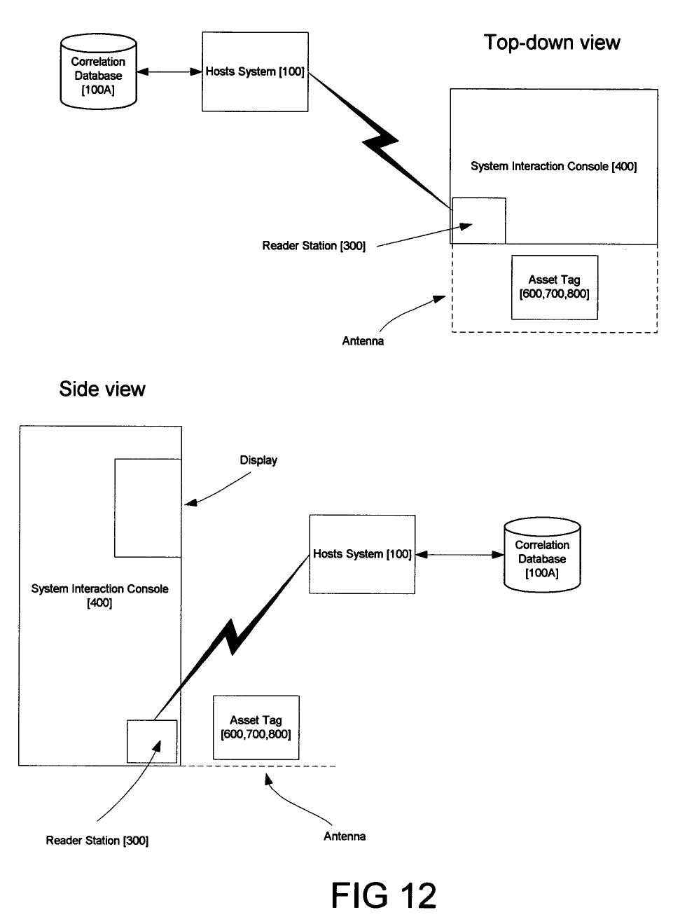

Other methods of registration consist of: The visitor or employee receiving the Asset tag [600,700] and attaching it to their lower extremity prior to approaching the registration employee located at a System Interaction Console [400]. Once the visitor or employee comes into vicinity of the System Interaction Console's [400] Reader Station's [300] Antenna, Refer to FIG. 12; the System Interaction Console [400] reads the Asset tag [600,700] attached to the lower extremity of the visitor/employee and is registered with the Host System [100] and assigned membership and e-commerce account information if desired.

Another method of registration consists of: The visitor or employee receiving an Asset tag [600,700] from a System Interaction Console [400] and performing a self-registration using the System Interaction Console [400] before approaching the admission purchase booth. This could include over the Internet purchases or off-facility purchases.

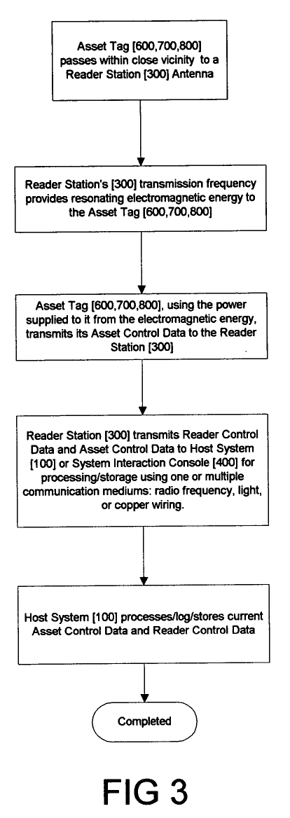

FIG. 3 is a flowchart of a method for transmitting control data in accordance with an exemplary embodiment of the present invention. Referring to FIG. 3; the process at which a Reader Station [300] communicates with the Host System [100], the Asset tags [600,700,800] as well as with other Reader Stations [300]. When an Asset tag [600,700,800] comes into close vicinity with a Reader Station's [300] Antenna(s). The Reader Station [300] resonates a frequency, which provides power to the Asset tag's [600,700,800] passive RFID transponder. The Asset tag [600,700,800], once powered, transmits Asset Control Data to the Reader Station [300] using wireless radio frequency. If the Asset tag [600,700,800] is receiving Asset Control Data from the Reader Station [300] then the process remains the same although the data is transmitted from the Reader Station [300] and received by the Asset tag [600,700,800] for storage within the Asset tag's [600,700,800] internal storage memory.

The Reader Station [300] receives the Asset Control Data and then transmits the Asset Control Data along with the Reader Control Data to the Host System [100] using communication protocols such as; wireless radio frequency, light or copper wiring. The Host System [100] then processes, logs or stores the Asset Control Data and Reader Control Data received using the Correlation Database [100A] to correlate the identity of the Asset Control Data to the registered information of the asset.

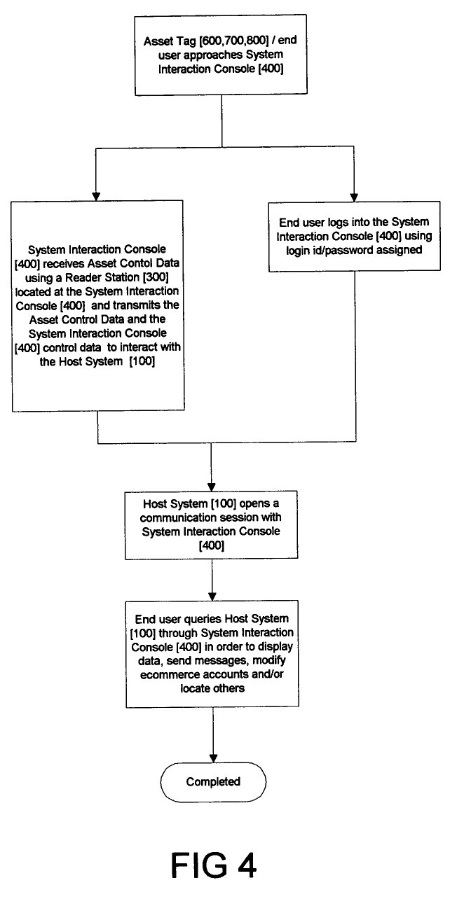

FIG. 4 is a flowchart of a method for interaction between the Host System [100] and an end user through the use of a System Interaction Console [400] in accordance with an exemplary embodiment of the present invention. FIG. 4 describes the process of the System Interaction Console [400] used by the end users to output, display, modify, transmit and utilize the data found on the Host System [100] and within the Correlation Database [100A]. A System Interaction Console [400] can be accessed in two different manners: One, the System Interaction Console [400], using a Reader Station [300] located at the System Interaction Console [400], communicates with the Asset tag [600,700,800] attached to the visitor, employee or equipment. The Asset Control Data transmitted from the Asset tag [600,700,800] is then transmitted to the Host System [100] and the Host System [100] returns the results to the System Interaction Console [400] for access and output. The Second method does not require a Reader Station [300] be located at the System Interaction Console [400]. The System Interaction Console [400] can grant access to the Host System [100] using a simple login identification/password prompt. Either of the System Interaction Console [400] access methods can be utilized in conjunction with the Host System [100] to provide output, display, input, modifications and communications to the end user.

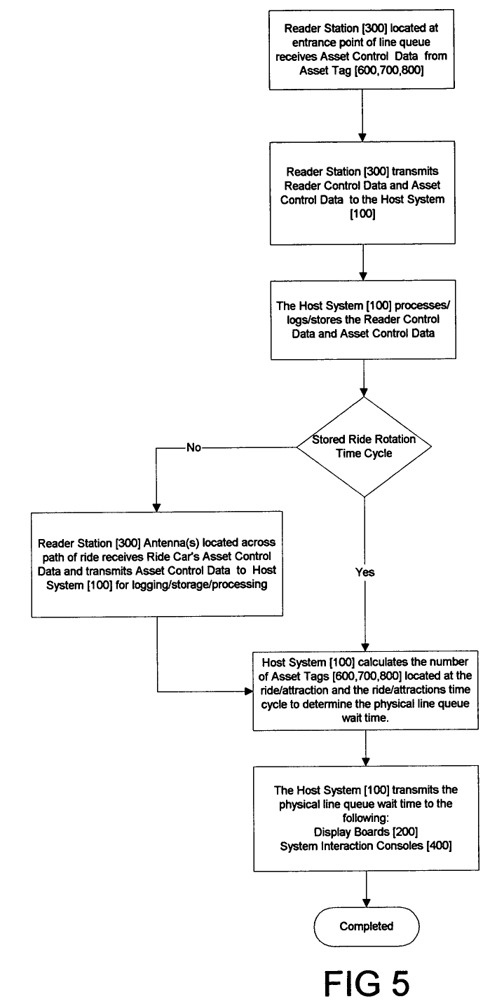

FIG. 5 is a flowchart of a method for the calculation and display of physical line queues in accordance with an exemplary embodiment of the present invention. The Reader Station [300] located at the entry point of a ride or attraction receives Asset Control Data as the asset enters the ride/attraction physical line queue. The Reader Station [300] then transmits the Asset Control Data received, including the Reader Control Data to the Host System [100] for processing/storage. If the physical line queue is for a ride/attraction that utilizes a track and or car, train or tram, referred to herein as a Ride Car, a Reader Station's [300] Antenna can be placed across the pathway of the Ride Car in order to transmit the Ride Car's Asset Control Data along with the Reader Control Data to the Host System [100] for processing/storage. The Host System [100] can then calculate the physical line queue wait time based on the formula:

(Number of Asset tags [600,700,800] currently in the line queue÷Ride Car asset volume)×ride or attraction time cycle=line queue wait time

Number of assets currently in the line queue is determined by identifying, through the use of Asset tag [600,700,800] positioning at the entry point of the ride or attraction.

Ride Car asset volume is a predefined value programmed into the Host System [100] as a variable based on Ride Car average volume. This value can also be determined in real-time with the use of a Reader Station's [300] Antenna being placed in close vicinity to the undercarriage of the Ride Car used to read the number of Asset tags [600,700,800] currently occupying the Ride Car. The Reader Station's [300] Antenna may also be placed at the entry position of the Ride Car in order to determine how many Asset tags [600,700,800] board the Ride Car.

Ride/attraction time cycles can be determined in two manners: The first is using an Asset tag [800] located on the Ride Car that positions the Ride Car on the ride's pathway in order to determine the length of time it requires for the Ride Car to go one cycle around the complete ride track. This allows for current time cycles to be determined by actual events of the ride/attraction and not set as the average time cycle predefined and programmed into the Host System [100]. The second method, a stored Ride Rotation Time Cycle, that consists of a predetermined programmed variable that identifies the ride/attractions average time cycle based on calculated average values.

Once the physical line queue calculation is completed, the Host System [100] can transmit the calculated results to Display Boards [200] and System Interaction Consoles [400] located throughout the area.

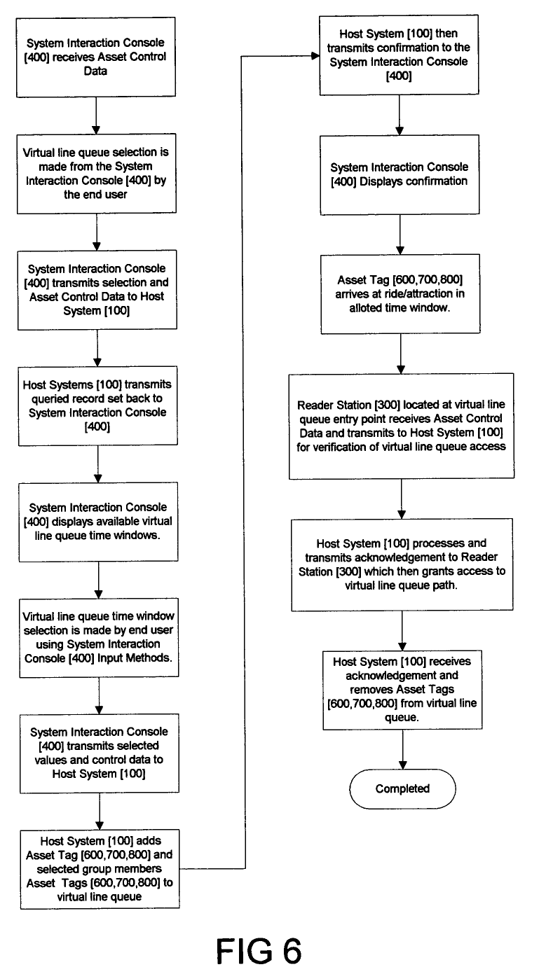

FIG. 6 is a flowchart of a method for the calculation, entry and display of virtual line queues in accordance with an exemplary embodiment of the present invention. Virtual line queues allow end users to enter a line queue for a ride or attraction in future time slots. When the time slot for an end user, that has entered the virtual line queue, has arrived, the end user approaches the virtual line queue path entry point and is granted or denied access to the special virtual line queue pathway. Disney Enterprises, Inc., has developed a system for entry into virtual line queues, referred to here as the FASTPASS System. Disney's FASTPASS System uses paper based ticket stubs that, when presented to an employee at the rides entrance, the employee grants or denies entrance to the FASTPASS entry lane. The present invention provides the ability to eliminate the need for an employee to grant or deny access and the end user's access is determined by the Host System [100] or System Interaction Console [400] and notifies the end user of access or denial via a turnstile or other means of notification into the virtual line queue pathway. Other systems have been disclosed that use active RFID transponder devices to be carried by the visitors throughout the park for virtual line queue entry. The present invention allows these functions using passive RFID transponders used in “free-flow” movement to determine the end user's admission into a virtual line queue.

Two methods are available for virtual line queue entry and selection: The first of which, Referring to FIG. 6; the System Interaction Console [400] receives the Asset Control Data using a Reader Station [300] located at the System Interaction Console [400] and transmits the Asset Control Data to the Host System [100] in order to identify the end user and then allows the end user to select entry into a virtual line queue. The end user is then prompted by the System Interaction Console [400] with choices of which virtual line queue they would like to join as well as which time slots are available for entry based on the Host System [100] response. Once the end user selects, using the System Interaction Console [400] Input Methods, the time slot and virtual line queue they wish to enter, the System Interaction Console [400] then transmits the results to the Host System [100] for processing/storage. The System Interaction Console [400] then informs the end user of the acceptance or denial of entry into the virtual line queue via output at the System Interaction Console [400] using the display or Output Printer [500]. If the end user has been accepted into the virtual line queue, the System Interaction Console [400] transmits Asset Control Data to the Asset tag [600,700,800], using the Reader Station [300] located at the System Interaction Console [400], to be stored on the Asset tag [600,700,800] in order to be granted access at the entry of the line queue when the time slot arrives for the end user's passage or stores the needed data on the Host System [100] for future reference.

The second method utilizes a System Interaction Console [400] independent of the Host System [100] that contains its own correlation database. The independent System Interaction Console [400] consists of a correlation database that stores virtual line queue time slots and availability data for which the end user selects from. A Reader Station [300] located at the independent System Interaction Console [400] receives the end user's Asset Control Data. The independent System Interaction Console [400] then displays the available time slots for the end user to select from. Once the end user selects their desired time slot, the independent System Interaction Console [400] transmits Asset Control Data to the Asset tag [600,700,800] via the Reader Station [300] that the Asset tag [600,700,800] stores in its internal memory storage for future reference.

Once the time slot arrives, the end user will arrive at the ride or attraction entry point, a Reader Station [300] located at the virtual line queue pathway entry point receives the Asset Control Data and transmit this data to the Host System [100] for validation or in the case of method two, the independent System Interaction Console [400] located at the virtual line queue entry point verifies the end users entry. Once the Host System [100] or independent System Interaction Console [400] validates the membership of the end user, the end user is granted access to the virtual line queue pathway via, turnstile, display or output. The Host System [100] or independent System Interaction Console [400] then removes the end user from the virtual line queue time slot stored on the Host System [100] or the independent System Interaction Console [400], using a Reader Station [300], removes the Asset Control Data from the Asset tag [600,700,800]. Another method available consists of a System Interaction Console [400] located at the virtual line queue entry point containing a Reader Station [300] that reads the Asset Control Data to determine if the end user has been granted access to the virtual line queue without accessing the Host System [100], using the Asset Control Data stored in the internal memory of the Asset tag [600,700,800]. This is available only if the system is designed to write the access control data to the Asset tag [600,700,800] when the end user registers for the virtual line queue.

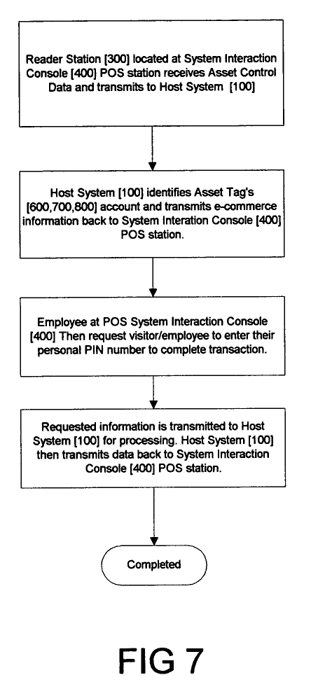

FIG. 7 is a flowchart of a method for the interaction between the System Interaction Console [400], Host System [100] and the end user during e-commerce account transactions in accordance with an exemplary embodiment of the present invention. E-commerce accounts or cashless accounts allow end users to make purchases without the use of exchanging hard currency. These systems use electronic data stored on media that can be added or subtracted from the media when purchases or credits are made. E-commerce accounts using RFID transponders to interact with systems have been disclosed in the past.

The present invention allows e-commerce accounts to be available to the end user throughout the area with the use of the System Interaction Console [400], Host System [100], Reader Station [300] and Asset tag [600,700,800]. There are two types of e-commerce accounts. Referring to FIG. 7; The first being an account that is managed on the Host System [100]. The second being an account managed on the Asset tag [600,700,800]. These e-commerce accounts can be established and based on any form of currency exchanged.

FIG. 7 refers to the first method of account management described above. Referring to FIG. 7; When an end user approaches a System Interaction Console [400] designated as a POS (Point of Sale) station, a Reader Station [300] located at the System Interaction Console [400] POS station, communicates with the end user's Asset tag [600,700,800] and identifies the end user as having an e-commerce account via the Host System [100] or Asset Control Data. The System Interaction Console [400] POS station then allows the user to make the purchase using their e-commerce account if desired. If the e-commerce account is managed by the Host System [100], the transaction is made with the Host System [100]. If the e-commerce account is managed on the Asset tag [600,700,800], as in the second method described above, then the transaction is made directly between the Asset tag [600,700] and the System Interaction Console [400] using the Reader Station [300] located at the POS station.

E-commerce accounts can be modified using the System Interaction Consoles [400] located throughout the area. E-commerce accounts can be divided among the Asset tags [600,700,800] within a membership group. This will allow end users, within a membership group, to share or distribute the account balance throughout their membership group if desired. Limits can be placed on certain accounts as well. For example: A family's membership group can have limits on each members purchasing amount. The father in the group may have full access to all the funds available in the account, whereas the son may only be allowed to use $50.00 of the accounts full balance.

For added security reasons, e-commerce purchases can require a Personal Identification Number (PIN) that is stored in the Host System's [100] memory storage or on the Asset tag's [600,700,800] internal memory storage that must be entered at the time of the purchase in order to identify the user of the e-commerce account. E-commerce account transactions are performed using the same communication methods used for positioning.

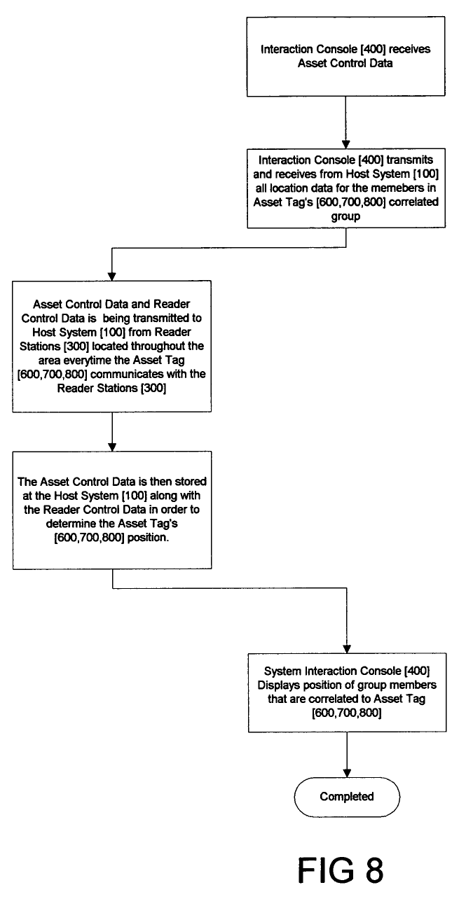

FIG. 8 is a flowchart of a method for locating assets using a System Interaction Console [400] in accordance with an exemplary embodiment of the present invention. End users of the system can locate assets throughout an area using the System Interaction Console [400]. Referring to FIG. 2; As an end user approaches a System Interaction Console [400], a Reader Station [300] located at the System Interaction Console [400], identifies the end user by their Asset tag [600,700,800]. Once the end user is identified, the System Interaction Console [400] then queries the Host System [100] for the current stored location data of the members within the Asset tag's [600,700,800] membership group. These locations are then displayed on the System Interaction Console [400] or printed using the Output Printer [500]at the System Interaction Console [400] in either list format or as images on a top-down view of the area.

FIG. 8 only pertains to locating members of an Asset tag's [600,700,800] membership group. Asset positioning is also capable of outputting the location of all assets throughout an area in detailed traffic flow analysis reports, after action reviews, and hot-spots. In this way, end users can locate and monitor the movement patterns and history of assets throughout a specified time frame queried. This allows end users to dispatch employees or equipment to areas based on current traffic, determine where marketing promotions and capital upgrades need to occur as well as increase security and personnel dynamically.

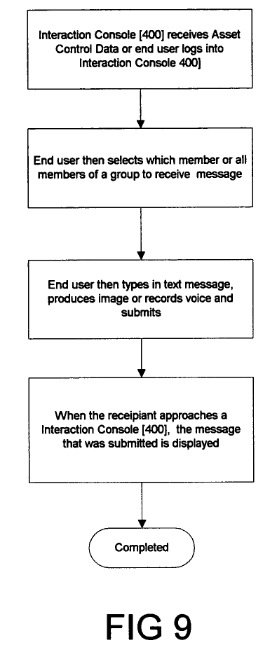

FIG. 9 is a flowchart of a method for communicating between end users using messaging services in accordance with an exemplary embodiment of the present invention. Messaging is available through the use of the system by allowing end users to send and receive messages from employees and other members of their group using the System Interaction Consoles [400]. When an end user approaches a System Interaction Console [400], a Reader Station [300] located at the System Interaction Console [400] communicates with the end user's Asset tag [600,700,800]. The Reader Station [300] then communicates with the Host System [100] to retrieve the Asset tag's [600,700,800] account data. The Host System [100] then transmits this data to the System Interaction Console [400]. The end user, once identified can then send messages using the System Interaction Console [400] to a member of their identified group or employees of the park, resort or facility. Employees can communicate with visitors and other employees as well. The end user types in their text message, records voice or images and submits using the System Interaction Console [400].

The message, when submitted, is transmitted to the Host System [100] from the System Interaction Console [400] and stored on the Host System [100]. When the receiving end user approaches a System Interaction Console [400], the Reader Station [300], located at the System Interaction Console [400], communicates with the end user's Asset tag [600,700,800] and transmits the Asset Control Data to the Host System [100] for identification and data retrieval. The Host System [100] then transmits back to the System Interaction Console [400], data associated with the Asset tag [600,700,800].

If a message is stored for the end user, it will be displayed or played on the System Interaction Console [400] for the end user to read, reply or remove from the Host System [100].

FIG. 10 is a diagram of a system for Reader Station [300] communication that allows for single point of reference positioning and multiple point of reference positioning. Referring to FIG. 10; Single point of reference positioning allows the Reader Station [300] to position Asset tags [600,700,800] to one particular point of reference in an area. Single point of reference requires one Reader Station [300] and one Reader Station's [300] Antenna. When Asset tags [600,700,800] cross over the Reader Station's [300] Antenna, the Reader Station's [300] resonating frequency provides the Asset tag [600,700,800] with the energy required for the Asset tag [600,700,800] to transmit the Asset Control Data to the Reader Station [300] . The Reader Station [300] then transmits the Asset Control Data, along with the Reader Control Data to the Host System [100] for processing and/or storage.

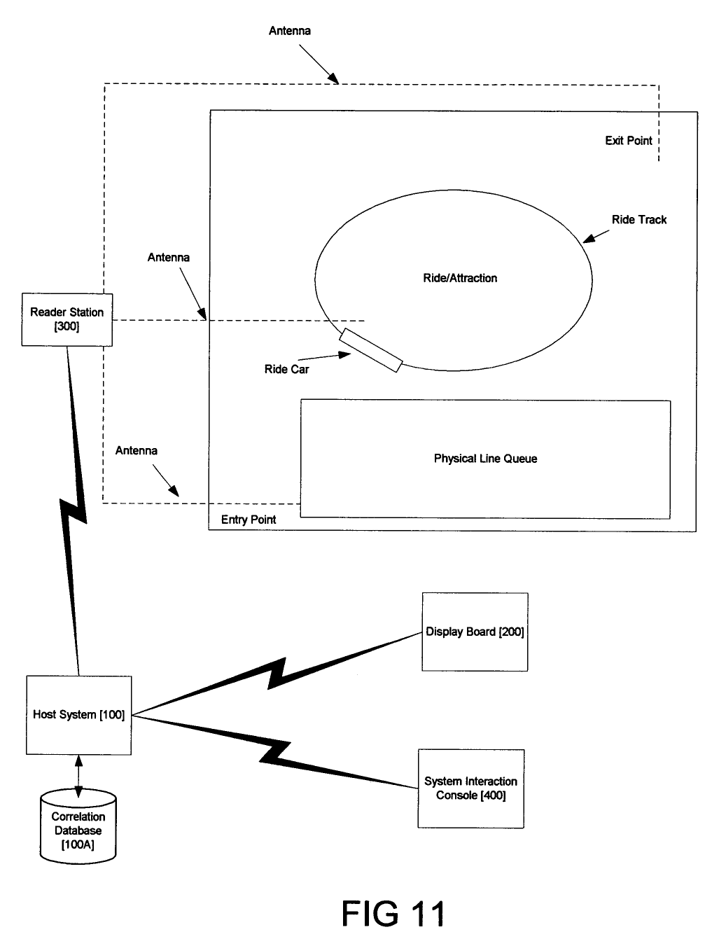

Referring to FIG. 11, multiple point of reference positioning allows a single Reader Station [300] to position Asset tags [600,700,800] in multiple points of reference within an area. This allows the reduction of the number of Reader Stations [300] required to position assets throughout the area. The multiple point of reference Reader Station [300] requires multiple Antennas, each Antenna having an identification designated within the Reader Station [300] such as an identification port, for one Reader Station [300]. The same concept applies for the single point of reference positioning reader configuration although, now multiple points of positioning reference is provided by one Reader Station [300].

In order to provide free-flow movement positioning, an area is divided into sectors, sectors are defined by boundaries, boundaries are created by Reader Station [300] Antenna(s). Referring to FIG. 10; Sector B's boundaries are defined by Sector A's Reader Station [300] Antenna position and Sector C's Reader Station [300] Antenna position, thus creating Sector B.

When an Asset tag [600,700,800] crosses Sector C Antenna/Sector B Boundary, the Sector C Reader Station [300] transmits Sector C Reader Station's [300] and Asset Control Data to the Host System [100] in order for the Host System [100] to position the asset within the area. The Asset tag [600,700,800] is defined as being in Sector C by the Host System [100] As the Asset tag [600,700,800] continues its free-flow movement and crosses Sector B Antenna/Sector C Boundary/Sector A Boundary, Sector B Reader Station [300] transmits Sector B Reader Station's [300] and Asset Control Data to the Host System [100] in order for the Host System [100] to position the asset within the area and the Asset tag [600,700,800] is now defined, by the Host System [100] as being in Sector B.

FIG. 11 is a diagram of a system that allows for physical line queue wait time calculations and display. The Reader Station's [300] Antenna(s), seen in FIG. 11 as a multiple positioning Reader Station [300] with multiple Antennas each Antenna containing an identification number within the Reader Station [300], can be placed at the entry and exit points of rides/attractions in order to determine Asset tags [600,700,800] entrance or exit. With the ability to determine the number of Asset tags [600,700,800] that have entered and/or exited a ride/attraction the system can determine the traffic flow for a particular ride/attraction. Using the line queue wait time calculation formula:

(Number of Asset tags [600,700,800] currently in the line queue÷Ride Car asset volume)×ride or attraction time cycle =line queue wait time

The Host System [100] can now determine the physical line queue wait time for a particular ride/attraction and display this value throughout the area using Display Boards [200] and/or System Interaction Consoles [400]. This empowers the end user to determine if they wish to attend the ride/attraction or if other actions should be taken based on the value.

Referring to FIG. 11, the Reader Station [300] has an Antenna placed across the pathway of the entrance to the ride/attraction that communicates with the Asset tags [600,700,800] as they enter the physical line queue. The Asset Control Data is then transmitted to the Host System [100] for processing, storing or logging. A Reader Station's [300] Antenna can be placed across the pathway of the Ride Car in order to communicate with the Asset tag [800] attached to the Ride Car to determine the ride/attraction's time cycle. This value is used to determine the amount of time needed by the ride/attraction to make one revolution. A Reader Station's [300] Antenna is placed across the exit pathway to determine the number of Asset tags [600,700,800] that have left the boundaries of the ride/attraction. With the information gathered by the Reader Stations [300], the Host System [100] can calculate and determine the physical line queue wait time and the Host System [100] can display these results on the Display Boards [200] and System Interaction Consoles [400] throughout the area.

FIG. 12 is a diagram of a system for System Interaction Console [400] communication that allows for the Asset tags [600,700,800] to be identified at the System Interaction Console [400] using “free-flow” movement in order to utilize the System Interaction Console [400] in accordance with an exemplary embodiment of the present invention. A Reader Station [300] is located at the System Interaction Console [400]. When an Asset tag [600,700,800] comes into the vicinity of the Reader Station's [300] Antenna, the Reader Station [300] receives the Asset Control Data and transmits the Asset Control Data to the Host System [100] for access to the System Interaction Console [400]. The Host System [100] then opens a communication session with the System Interaction Console [400]. The end user can now query the Host System [100] for information about the park, resort or facility as well as modify their e-commerce account, join virtual line queues, send messages to other end users and locate other assets throughout an area.

The System Interaction Console [400] can communicate with the Asset tags [600,700,800] and Host System [100] through the communication medias associated with the Reader Station [300] The end user communicates with the System Interaction Consoles [400] using the System Interaction Console [400] Input Methods. The System Interaction Console [400] can also write Asset Control Data to the end user's Asset tag [600,700,800] for internal memory storage using the Reader Station [300] located at the System Interaction Console [400].

What is claimed is

1. A system for tracking mobile assets in an area defined by multiple sectors, the system comprising:
an asset tag that includes an RFID transponder operable to store an Identification Data, the Identification Data associated with the RFID transponder and may be correlated with an Asset Identification Data associated with a mobile asset;
a Host System that includes a Correlation Database that correlates the Asset Identification Data and the Identification Data associated with the RFID transponder;
a System Interaction Console in communication with the Host System, the System Interaction Console operable to receive the Asset Identification Data and the Identification Data associated with the RFID transponder, and to communicate the Asset Identification Data and the Identification Data associated with the RFID transponder to the Host System to correlate the Asset Identification Data and the Identification Data associated with the RFID transponder through the correlation database;
a sector Reader Station identified by a Reader Station Identification Data and including an Antenna that is associated with a boundary of a sector of the area, the sector Reader Station operable to receive the Identification Data associated with the RFID transponder using the Antenna and to communicate the Identification Data associated with the RFID transponder to the Host System, wherein the Host System correlates the Identification Data associated with the RFID transponder and the Reader Station Identification Data, which is associated with the Antenna and the boundary of the sector of the area; and
a Display Board in communication with the Host System and operable to display one or more sectors of the area and to display the location of the mobile asset.

2. The system of claim 1, wherein the mobile asset is a human and the Asset tag is attached to the lower extremity of the human.

3. The system of claim 1, wherein the mobile asset is a piece of equipment and the Asset tag is attached to the lower portion of the piece of equipment.

4. The system of claim 3, wherein the lower portion of the piece of equipment is an undercarriage of the piece of equipment.

5. The system of claim 1, wherein a Reader Station Antenna is across a pathway to create a boundary of a sector within an area.

6. The system of claim 1, wherein the Reader Station Identification Data is a unique value.

7. The system of claim 6, wherein the Reader Station Identification Data is determined by a port address.

8. The system of claim 6, wherein the Reader Station Identification Data is determined by a predefined variable stored within the Reader Station.
